(19) United States
(12) Patent Application Publication
(10) Pub. No.: US 2025/0250470 A1
(43) Pub. Date: Aug. 7, 2025

(54) FLOORING ADHESIVE AND METHODS OF JOINING FLOORING SEGMENTS

(71) Applicant: Tarkett USA Inc., Solon, OH (US)

(72) Inventors: Melissa A. Starling, Rocky Face, GA (US); Isaac A. Wheat, Crandall, GA (US); David L. Wilkinson, Dalton, GA (US)

(21) Appl. No.: 19/048,037

(22) Filed: Feb. 7, 2025

Related U.S. Application Data
(60) Provisional application No. 63/550,673, filed on Feb. 7, 2024.

(51) Int. Cl. C09J 129/14; C09J 5/00; E04F 15/02

(52) U.S. Cl. CPC C09J 129/14; C09J 5/00; E04F 15/02155; C09J 2400/266; C09J 2459/00

(57) ABSTRACT

Embodiments disclosed provide compositions which may include from 10 weight percent (wt. %) to 60 wt. % of a polyvinyl butyral resin and from 40 wt. % to 90 wt. % of an organic solvent. The compositions may have a viscosity from 100 to 100,000 centipoise. Embodiments disclosed herein may also provide methods of joining a textile segment to a textile segment, a textile segment to a resilient floor covering, or a resilient floor covering to a resilient floor covering, and methods for joining the foregoing where each textile segment or resilient floor covering having at least one edge. The method may include applying the composition to a first textile segment or floor covering, contacting a second textile segment or floor covering, and evaporating at least a portion of the organic solvent in the composition. Subsequent to the evaporating, the first floor covering segment is joined to the second floor covering segment.

### CROSS REFERENCE TO RELATED APPLICATIONS

The nonprovisional application claims priority to and the benefit of U.S. Provisional Patent Application No. 63/550,673, filed on Feb. 7, 2024, entitled “Compositions Comprising a Polyvinyl Butyral Resin and an Organic Solvent and Methods of Joining Separate Carpet Segments”, which we incorporate by reference in its entirety.

### FIELD

The present disclosure relates to adhesive compositions, and more specifically to compositions capable of joining or seam welding floor coverings or segments of floor coverings; the adhesive compositions comprising a polyvinyl butyral resin and an organic solvent.

The disclosure further relates to methods of joining or seam welding floor coverings or segments of floor coverings using the adhesive compositions.

### BACKGROUND

When installing floor coverings such as textile or resilient floor covering it is common for the room in which the floor covering is being installed to have at least one dimension (length or width) that is greater than the length of a standard roll of floor covering. In such cases, a unitary segment of flooring from a roll cannot cover the entire floor of the room, and two or more segments must be pieced together. When two or more segments are pieced together, an edge of one segment is abutted against an edge of another segment, and these edges are joined or “seamed” together to provide an appearance and a function of a single segment of flooring. Conventional compositions used to join or seam together floor coverings may include polymer resins in water that suffer from increased drying time and/or a reduced bonding strength between joined floor covering segments.

### SUMMARY

Resin-based adhesives may be used to join segments of floor coverings. A resin may be dissolved or suspended in a liquid to form a resin-based adhesive. Subsequent to applying the resin-based adhesive composition between flooring segments, the liquid is removed to bond the resin in the resin-based adhesive. Polyvinyl butyral resins may be used in resin-based adhesive compositions. Conventional compositions that include polymer resins dissolved in water may suffer from increased drying time and/or reduced bonding strength between joined floor covering segments when compared to floor covering segments joined by polymer resins dissolved in an organic solvent.

Embodiments disclosed herein provide compositions that include polyvinyl butyral resin and an organic solvent. Such compositions may be useful in a variety of applications that require joining floor coverings, such as joining carpet or carpet segments together (i.e. seam welding). The compositions disclosed herein may reduce the drying time needed to form a durable weld between floor coverings and/or may increase the bonding strength of joined floor coverings compared to conventional compositions used for joining floor coverings such as seam welding carpet segments, joining carpet to resilient flooring, or joining resilient flooring to resilient flooring.

According to one or more embodiments of the present disclosure, a composition for joining a textile to a textile, a textile to a resilient floor covering, or a resilient floor covering to a resilient floor covering comprising from 10 weight percent (wt. %) to 60 wt. % of a polyvinyl butyral resin; and from 40 wt. % to 90 wt. % of an organic solvent is provided, wherein the composition has a viscosity from 100 to 100,000 centipoise (cP).

According to one or more embodiments of the present disclosure, a composition for joining a textile to a textile, a textile to a resilient floor covering, or a resilient floor covering to a resilient floor covering comprising from 10 wt. % to 60 wt. % of a polyvinyl butyral resin; from 40 wt. % to 90 wt. % of an organic solvent; from 0 wt. % to 2 wt. % water; from 0 wt. % to 25 wt. % plasticizers; from 0 wt. % to 1 wt. % pigments; from 0 wt. % to 1 wt. % antioxidants; and from 0 wt. % to 1 wt. % additives or impurities retained in recycled content, is provided.

According to one or more embodiments of the present disclosure, a composition for joining a textile to a textile, a textile to a resilient floor covering, or a resilient floor covering to a resilient floor covering is provided, the composition comprising from 15 wt. % to 40 wt. % of a polyvinyl butyral resin; and from 60 wt. % to 85 wt. % of an organic solvent; wherein: the polyvinyl butyral resin has an average molecular weight of from 33,000 g/mol to 55,000 g/mol; the polyvinyl butyral resin has a degree of acctalization from 0.7 mol. % to 3 mol. %; the polyvinyl butyral resin has a polyvinyl hydroxyl content from 12 wt. % to 21 wt. %; the organic solvent comprises alcohol, methyl acetate, acetone, or all; and the composition has a viscosity of from 1,000 to 3,000 centipoise, as measured according to ASTM 2196, is provided.

According to one or more embodiments of the present disclosure, a method of joining a first textile segment and a second textile segment is provided, the method comprising applying the composition of claim 1 to a first edge of the first carpet segment, or a second edge of the second carpet segment, or both, and contacting the first edge and the second edge.

According to one or more embodiments of the present disclosure, a method of joining a flooring segment or floor covering segment including but not limited to a textile segment, and a resilient floor covering segment, the method comprising applying the composition of claim 1 to an edge of the textile segment, or an edge of the resilient floor covering segment, or both; and contacting the edge of the textile segment and the edge of the resilient floor covering segment. It should be understood that a textile segment can be, but is not limited to, a carpet segment.

According to one or more embodiments of the present disclosure, a method of joining a first resilient floor covering segment and a second resilient floor covering segment is disclosed, the method comprising applying the composition of claim 1 to an edge of the first resilient floor covering segment, or an edge of the second resilient floor covering segment, or both; and contacting the edge of the first resilient floor covering segment and the edge of the second resilient floor covering segment.

According to one or more embodiments of the present disclosure, a method of joining a first resilient floor covering segment and a second resilient floor covering segment is disclosed, the method comprising applying the composition of claim 1 to a side of the first resilient floor covering segment, or a side of the second resilient floor covering segment, or both; and contacting the side of the first resilient floor covering segment and the side of the second resilient floor covering segment.

According to one or more embodiments of the present disclosure, a material comprising the composition according to claim 1 is disclosed; a first segment comprising or composed of a textile or a resilient floor covering; and a second segment comprising or composed of a textile or a resilient floor covering, wherein the composition is between the first segment and the second segment, and the composition durably joins the first segment and the second segment together.

Additional features and advantages will be set forth in the detailed description which follows, and in part will be readily apparent to those skilled in the art from the description or recognized by practicing the embodiments as described in the written description and claims hereof.

It is to be understood that both the foregoing summary and the following detailed description are merely exemplary and are intended to provide an overview or framework to understand the nature and character of the claims.

### BRIEF DESCRIPTION OF THE DRAWINGS

FIG. 1A is a top view of an example of the composition joining a first flooring segment and a second flooring segment.

FIG. 1B is a front view of an example of the composition joining a first flooring segment and a second flooring segment.

FIG. 1C is a front view of an example of the composition joining a first flooring segment and a second flooring segment.

FIG. 1D is a front view of an example of the composition joining a first flooring segment and a second flooring segment.

FIG. 2A is a top view of an example of the composition joining a top side of a first flooring segment and a bottom side of a second flooring segment.

FIG. 2B is a front view of an example of the composition joining a top side of a first flooring segment and a bottom side of a second flooring segment.

FIG. 2C is a front view of an example of the composition joining a bottom side of a first flooring segment and a top side of a second segment.

FIG. 2D is a front view of an example of the composition joining a top side of a first flooring segment and a bottom side of a second flooring segment.

### DETAILED DESCRIPTION

The present disclosure is directed to compositions comprising a polyvinyl butyral resin and an organic solvent. In embodiments, the composition may comprise from 10 weight percent (wt. %) to 60 wt. % of a polyvinyl butyral resin; and from 40 wt. % to 90 wt. % of an organic solvent; wherein the composition has a viscosity of from 100 cP to 100,000 cP as measured according to ASTM D2196. The composition may be used to join or seam weld textile segments together, and textile segments may include carpet segments. The composition may also be used to join or seam weld a textile segment to a resilient floor covering (such as including but not limited to non-textile). A resilient floor covering may include vinyl sheet, PVC-based vinyl sheet, or PVB-based vinyl sheet. A resilient floor covering could be either a homogenous composition or a heterogenous compositions that include at least one layer of PVC, PVB, or a compatible polymer.

The polyvinyl butyral resin may have an average molecular weight of from 10,000 g/mol to 250,000 g/mol, such as from 10,000 g/mol to 15,000 g/mol, from 15,000 g/mol to 20,000 g/mol, from 20,000 g/mol to 25,000 g/mol, from 25,000 g/mol to 30,000 g/mol, from 30,000 g/mol to 33,000 g/mol, from 33,000 g/mol to 35,000 g/mol, from 35,000 g/mol to 40,000 g/mol, from 40,000 g/mol to 45,000 g/mol, from 45,000 g/mol to 50,000 g/mol, from 50,000 g/mol to 55,000 g/mol, from 55,000 g/mol to 60,000 g/mol, from 60,000 g/mol to 65,000 g/mol, from 65,000 g/mol to 70,000 g/mol, from 70,000 g/mol to 75,000 g/mol, from 75,000 g/mol to 80,000 g/mol, from 80,000 g/mol to 85,000 g/mol, from 85,000 g/mol to 90,000 g/mol, from 90,000 g/mol to 95,000 g/mol, from 95,000 g/mol to 100,000 g/mol, from 15,000 g/mol to 125,000 g/mol, 15 20,000 g/mol to 150,000 g/mol, from 15,000 g/mol to 200,000 g/mol, from 15,000 g/mol to 225,000 g/mol, from 15,000 g/mol to 250,000 g/mol, or any combination of one or more of these ranges.

The polyvinyl butyral resin may have a degree of acetalization of from 0 mol % to 20 mol %, such as from 0 mol % to 5 mol %, from 0 mol % to 3 mol %, from 0.5 mol % to 5 mol %, from 0.7 mol % to 3 mol %, from 5 mol % to 10 mol %, from 10 mol % to 15 mol %, 15 mol % to 20 mol %, or any combination of one or more of these ranges.

The polyvinyl butyral resin may have a polyvinyl hydroxyl content of from 10 wt. % to 30 wt. % based on the moles of the polyvinyl butyral resin in the composition. The polyvinyl hydroxyl content may range from 10 wt. % to 15 wt. %, from 15 wt. % to 20 wt. %, from 20 wt. % to 25 wt. %, from 25 wt. % to 30 wt. %, from 12 wt. % to 21 wt. %, or any combination of one or more of these ranges.

In embodiments, the polyvinyl butyral resin may be a virgin resin, a recycled post-consumer resin, a recycled post-industrial resin, or combinations thereof. In embodiments, the compositions disclosed herein may include one or more additives retained in the recycled content, such as calcium carbonate, calcium stearate, stearic acid, wax, 1-methyl-2-pyrrolidinone, acrylic polymers, polyester, polyurethanes, nylon, silicon dioxide, or combinations thereof.

The organic solvent of the composition may include at least one of an alcohol, an ether, an ester, a ketone, a hydrocarbon, terpineol, butyl carbitol, acetic acid, dimethyl sulfoxide, or combinations thereof. In embodiments, the organic solvent of the composition may be selected from the group consisting of an alcohol, an ether, an ester, a ketone, a hydrocarbon, terpineol, butyl carbitol, acetic acid, dimethyl sulfoxide, and combinations thereof.

In embodiments where the organic solvent includes an alcohol, the alcohol may comprise, consist essentially of, or consist of methanol, ethanol, propanol, isopropanol, butanol, isobutanol, diacetone alcohol, benzyl alcohol, and combinations thereof. As used throughout the present disclosure, the phrase “consist essentially of” refers to comprising greater than or equal to 99 wt. % of the recited species, unless stated otherwise. For instance, when the organic solvent comprises an alcohol consisting essentially of methanol, ethanol, propanol, isopropanol, butanol, isobutanol, diacetone alcohol, benzyl alcohol, and combinations thereof, it should be understood that greater than or equal to 99 wt. % of alcohol present in the composition is methanol, ethanol, propanol, isopropanol, butanol, isobutanol, diacetone alcohol, benzyl alcohol, and combinations thereof.

In embodiments where the organic solvent includes an ether, the ether may comprise, consist essentially of, or consist of dioxane, tetrahydrofuran, a glycol ether, and combinations thereof. Examples of suitable glycol ethers may include but not be limited to 1-methoxy propanol-2, butyl glycol, 3-methyoxy-butanol-1, ethylene glycol monomethyl ether, ethylene glycol monoethyl ether, ethylene glycol monobutyl ether, dipropylene glycol n-butyl ether, and combinations thereof. In embodiments, the glycol ether may be at least one selected from 1-methoxy propanol-2, butyl glycol, 3-methyoxy-butanol-1, ethylene glycol monomethyl ether, ethylene glycol monoethyl ether, ethylene glycol monobutyl ether, dipropylene glycol n-butyl ether, and combinations thereof.

In embodiments where the organic solvent includes an ester, the ester may comprise, consist essentially of, or consist of methoxy propyl acetate, methyl acetate, ethyl acetate, butyl acetate, acetic acid-3-methoxy-n-butylester, glycolic acid-n-butylester, dibasic esters, ethyl lactate, and combinations thereof.

In embodiments where the organic solvent includes a ketone, the ketone may comprise, consist essentially of, or consist of acetone, methylethylketone, methylisobutylketone, cyclohexanone, and combinations thereof.

In embodiments where the organic solvent includes a hydrocarbon, the alcohol may comprise, consist essentially of, or consist of an aliphatic hydrocarbon, toluene, xylene, and combinations thereof.

In embodiments, the organic solvent may comprise, consist essentially of, or consist of alcohol, methyl acetate, acetone, and combinations thereof.

The organic solvent may comprise from 0 wt. % to 100 wt. % of the alcohol, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the ether, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the ester, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the ketone, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the hydrocarbon, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of terpineol, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the butyl carbitol, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the acetic acid, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The organic solvent may comprise from 0 wt. % to 100 wt. % of the dimethyl sulfoxide, such as from 1 wt. % to 99 wt. %, from 5 wt. % to 95 wt. %, from 10 wt. % to 90 wt. %, from 20 wt. % to 80 wt. %, from 30 wt. % to 70 wt. %, from 40 wt. % to 60 wt. %, from 45 wt. % to 55 wt. %, or from any and all ranges and sub-ranges between the foregoing values, based on the total weight of the organic solvent.

The composition may have a viscosity of from 100 cP to 100,000 cP, as measured according to ASTM D2196. For instance, the composition may have a viscosity of from 100 cP to 100,000 cP, from 200 cP to 75,000 cP, from 300 cP to 50,000 cP, from 400 cP to 25,000 cP, from 450 cP to 10,000 cP, from 500 cP to 8,000 cP, from 750 cP to 7,000 cP, from 900 cP to 5,000 cP, from 1,000 cP to 3,000 cP, or any combination of one or more of these ranges, as measured according to ASTM D2196. Without intending to be bound by any particular theory, it is believed that if the viscosity of the composition is too low, the composition may not adhere to a carpet segment during the application process. Further, it is believed that if the viscosity of the composition is too high, the composition may not be easily applied to a carpet segment.

The composition may include from 10 wt. % to 60 wt. % of the polyvinyl butyral resin, such as from 10 wt. % to 15 wt. %, from 15 wt. % to 20 wt. %, from 20 wt. % to 25 wt. %, from 25 wt. % to 30 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 32 wt. % to 58 wt. %, from 34 wt. % to 56 wt. %, from 36 wt. % to 54 wt. %, from 38 wt. % to 52 wt. %, from 40 wt. % to 50 wt. %, from 42 wt. % to 48 wt. %, from 44 wt. % to 46 wt. %, or from any and all ranges and sub-ranges between the foregoing values, based on the total weight of the composition.

The composition may include from 40 wt. % to 90 wt. % of the organic solvent, such as from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, from 42 wt. % to 68 wt. %, from 44 wt. % to 66 wt. %, from 46 wt. % to 64 wt. %, from 48 wt. % to 62 wt. %, from 50 wt. % to 60 wt. %, from 52 wt. % to 58 wt. %, from 54 wt. % to 56 wt. %, or from any and all ranges and sub-ranges between the foregoing values, based on the total weight of the composition.

The composition may include one or more components in addition to the polyvinyl butyral resin and the organic solvent.

The composition may comprise from 0 wt. % to 2 wt. % water, based on the total weight of the composition, such as from 0 wt. % to 0.5 wt. %, from 0.5 wt. % to 1.0 wt. %, from 1.0 wt. % to 1.5 wt. %, from 1.5 wt. % to 2.0 wt. %, or any combination of one or more of these ranges. In embodiments, the composition may include less than 2 wt. %, less than 1 wt. %, less than 0.1 wt. % or 0 wt. % water.

In embodiments, the composition may comprise from 0 wt. % to 25 wt. % of one or more plasticizers, one or more pigments, one or more antioxidants, or combinations thereof, such as from 0 wt. % to 5.0 wt. %, from 5.0 to 10.0 wt. %, from 10.0 wt. % to 15 wt. %, from 15 wt. % to 20.0 wt. %, from 20.0 wt. % to 25.0 wt. %, or any combination of one or more of these ranges.

In embodiments, the composition may comprise, consist essentially of, or consist of from 10 wt. % to 60 wt. % of the polyvinyl butyral resin; from 40 wt. % to 90 wt. % of the organic solvent; from 0 wt. % to 2 wt. % water, from 0 wt. % to 25 wt. % plasticizers, from 0 wt. % to 3 wt. % pigments, from 0 wt. % to 1 wt. % antioxidants.

Embodiments described herein may also include methods of joining separate carpet segments using the compositions described in the present disclosure.

A method of joining a first textile segment and a second textile segment, each carpet segment having at least one edge, may include applying the composition to a first edge of a first carpet segment, applying the composition to a second edge of the second carpet segment, or both.

The method may further include, contacting a second edge of the second carpet segment to the first edge of the first carpet segment. The contacting may be carried out subsequent to applying the composition to the first edge of the carpet segment, the second edge of the carpet segment, or both. In embodiments, the second edge of the second carpet segment may contact the first edge of the first carpet segment prior to applying the composition to the first edge of the first carpet segment, the second edge of the second carpet segment, or both the first edge and the second edge. The contacting may be carried out prior to applying the composition to the first edge of the carpet segment, the second edge of the carpet segment, or both. In embodiments, the second edge of the second carpet segment may contact the first edge of the first carpet segment prior to applying the composition to the first edge of the first carpet segment, the second edge of the second carpet segment, or both. In embodiments, a first portion of the composition may be applied to the first edge of the first carpet segment, the second edge of the second carpet segment, or both prior to the contacting, and a second portion of the composition may be applied to the first edge of the first carpet segment, the second edge of the second carpet segment, or both subsequent to the contacting.

The method may further include evaporating at least a portion of the organic solvent in the composition, wherein subsequent the evaporating, the first carpet segment may be joined to the second carpet segment. The evaporating may include passive evaporation (i.e. allowing at least a portion of the organic solvent to evaporate at ambient temperature). In other embodiments, an external heat source may be applied to reduce a time needed for the organic solvent to evaporate.

As noted previously, embodiments of the present disclosure include from 10 wt. % to 60 wt. % of a polyvinyl butyral resin and from 40 wt. % to 90 wt. % of an organic solvent, wherein the composition has a viscosity from 100 cP to 100,000 cP. Such compositions may be useful in a variety of applications, such as joining separate carpet segments together. The compositions disclosed herein may reduce the drying time needed and/or may increase the bonding strength between separate carpet segments compared to conventional compositions.

### EXAMPLES

The various aspects of the present disclosure will be further clarified by the following examples. The examples are illustrative in nature and should not be understood to limit the subject matter of the present disclosure.

### Example 1: Preparation of Compositions

In Example 1, compositions according to the present disclosure were prepared. The materials used in preparing the compositions of Example 1 are provided below in Table 1.

TABLE 1

| Chemical | Supplier |
|---|---|
| Polyvinyl butyral resin MOWITAL ® B 30 H | Kuraray |
| Polyvinyl butyral resin MOWITAL ® B 60 HH | Kuraray |
| C-XL Seam Sealer | Tarkett |
| Acetone | |
| Methyl Acetate | |

To prepare the compositions of Example 1 (1A-1D), the polyvinyl butyral resins were dissolved in an organic solvent according to Table 2.

TABLE 2

| | Polyvinyl | | Wt. % of | | Viscosity |
|---|---|---|---|---|---|
| Example | butyral resin | Solvent | resin | | range (cP) |
| 1A | B 30 H | Acetone | 37 | wt. % | 2,000-2,700 |
| 1B | B 60 HH | Acetone | 24 | wt. % | 1,800-2,100 |
| 1C | B 30 H | Methyl acetate | 30 | wt. % | 1,600-3,000 |
| 1D | B 60 HH | Methyl acetate | 18.5 | wt. % | 1,000-1,100 |

A commercially available water-based seam sealer (C-XL Seam Sealer) was used as-is and is denoted as Comparative Example A.

### Example 2: Evaluation of Joined Carpet Segments Using the Compositions of Example 1

In Example 2, carpet segments were joined together using the compositions of Example 1. Specifically, a first carpet segment (Powerbond® ethos® supplied by Tarkett) having a size of 18 in (L)×6 in (W)×0.2 in (H) and a second carpet segment identical to the first carpet segment were provided. The composition (Exs. 1A, 1B, 1C, 1D, or Comp. Ex. A) was applied as a 1/8 in minimum wide bead along the width edge of the first carpet segment. The width edge of the second carpet segment was positioned to contact the width edge of the first carpet segment such that the composition contacted both the first carpet segment and the second carpet segment at a seam weld. The seam weld was allowed to dry at the designated time (4, 7, 24, or 48 hrs). After the set duration or time interval, samples were cut at 4.75″×2.5″ where the seam is in the center of the sample parallel to the 2.5″ length. The strength of the joined carpet segments were tested using an Instron 3365. Grips were 3″ wide and set at 3″ inches apart at the beginning of the test. The test was initiated after balancing the force and zeroing displacement. The Instron 3365 instrument then pulled the sample at 12.00 in/min measuring force at a sensitivity of 40%. Force was measured every 50.00 ms. Once the sample separated at the seam weld, the maximum load in lb_{f} was recorded to the one-hundredth decimal place. The testing methods described here are further described in ASTM D2646 and ASTM D5034. The strength of the joined carpet segments was measured after four separate drying periods (4 hours, 7 hours, 24 hours, and 48 hours), as determined by the breaking force at failure of the joined carpet segments and is reported in Table 3.

TABLE 3

Drying time:

| | | | |
|---|---|---|---|
| 4 hours | 7 hours | 24 hours | 48 hours |

| | |
|---|---|
| Example | Breaking Force (pounds force) |

| | | | | |
|---|---|---|---|---|
| Ex. 1A | 63 | 71 | 97 | 113 |
| Ex. 1B | 48 | 51 | 64 | 90 |
| Ex. 1C | 53 | 64 | 97 | 129 |
| Ex. 1D | 56 | 55 | 80 | 112 |
| Comp. Ex. A | 0 | 0 | 29 | 61 |

As shown in Table 3, after 6 hours of drying, the Example using the water-based comparative example (Comp. Ex. A) did not sufficiently join to sustain any force. The Examples (1A-1D) exhibited increased strength after 4 hours of drying. Further, after 24 hours and 48 hours of drying, the Examples (1A-1D) exhibited increased strength relative to the water-based comparative example. Embodiments described herein that include a polyvinyl butyral resin and an organic solvent to join separate carpet segments may demonstrate decreased drying time and increased strength relative to other comparative compositions.

### Example 3: Evaluation of Joined Carpet Segments in Real-World Application

In Example 3, carpet segments were installed and joined together using composition 1C in Example 1. Feedback from the installation team using seam weld 1C included a more uniform application, improved time to join carpet segments, and enhanced usability compared to other seam welds.

Various aspects of the subject disclosure are now described in more detail with reference to the annexed drawings, wherein like numerals generally refer to like or corresponding elements throughout. It should be understood that the drawings and detailed description are not intended to limit the claimed subject matter to the particular form disclosed. Instead, the intention is to cover all modifications, equivalents, and alternatives falling within the spirit and scope of the claimed subject matter. It should, of course, be understood that the description and drawings herein are merely illustrative, and that various modifications and changes can be made in the structures disclosed without departing from the present disclosure.

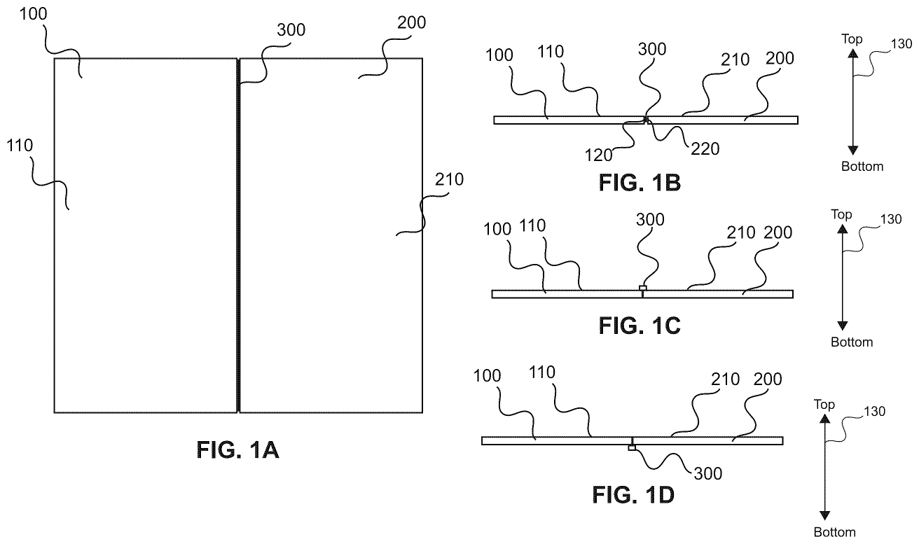

Referring to FIGS. 1A-1D, a first flooring covering segment 100 is joined to a second flooring covering segment 200 by the composition 300 along an edge 120 of the first floor covering segment 100 and an edge 220 of the second floor covering segment 200. In an embodiment, a method where the first floor covering segment 100 and the second floor covering segment 200 are joined by applying the composition 300 to an edge of a first floor covering segment 100, or an edge of a second floor covering segment 200, or both; and contacting the first edge 120 and the second edge 220 is disclosed. In this fashion, the composition 300 is provided or disposed between the segments 100, 200. Alternatively, contacting the first edge 120 and the second edge 220, and applying the composition 300 to the first floor covering segment 100 and/or the second floor covering segment 200. As shown in FIG. 1C, the composition 300 may be applied to a top side 110 of the first floor covering segment 100 and/or to a top side 210 of a second flooring covering segment 200. An arrow 130 indicates the top and bottom direction indicating the top side and bottom side of the floor covering segments. If the flooring covering is permeable to the composition 300, the composition 300 when applied may soak or absorb into the first and the second flooring segments where it joins the flooring segments. As shown in FIG. 1D, the composition 300 may also be applied to a bottom side of the first flooring segment 100 and/or a bottom side of the second flooring segment 200. The first flooring covering segment 100 may be comprised of a textile flooring or a resilient floor covering. The second floor covering segment 200 may be comprised of a textile or a resilient floor covering. It should be understood that the segments may comprise a cellular structure as understood to one skilled in the art, and thus may be permeable or impermeable.

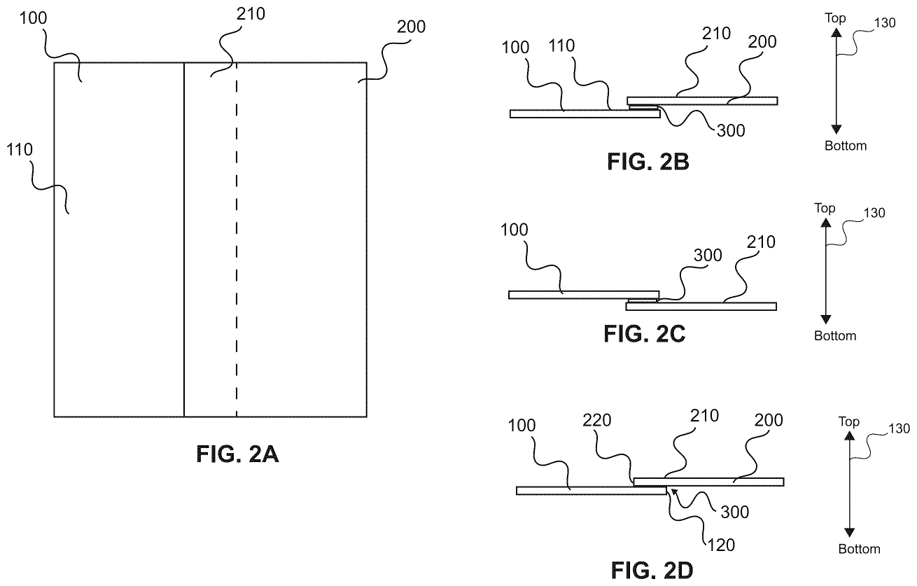

Now referring to FIGS. 2A-2D, in an embodiment the first floor covering segment 100 and the second floor covering segment 200 may overlap. As shown in FIG. 2A, the second floor covering segment 200 may overlap the top side 110 of the first floor covering segment 100. As shown in FIG. 2B, the composition 300 may be between the top side 110 of the first flooring covering segment 100 and the bottom side of the second flooring covering segment 200. Alternatively, the composition 300 may be between the bottom side of the first floor covering segment 100 and the top side 210 of the second floor covering segment 200, as shown in FIG. 2C. Alternatively, as shown in FIG. 2D, the composition 300 may be applied where the first edge 120 meets the bottom side and/or where the second edge 220 meets the top side 110, and the composition 200 should be interpreted as being between the first floor covering segment 100 the second floor covering segment 200. The composition 300 may durably join the first floor covering segment 100 the second floor covering segment 200.

The order in which one or more or all of the method steps are described should not be construed as to imply that these steps are necessarily order dependent. Alternative ordering of steps will be appreciated based on this description. Further, not all steps may necessarily be present in each aspect provided herein.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” or “consists essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. “Flooring” and “floor coverings” are intended to be used interchangeably in the present application. A “first segment” and a “second segment” may be part of a unitary piece of flooring or a “first segment” may be on a first piece of flooring and a “second segment” may be on a second piece of flooring. The use of a “first segment” and a “second segment” alone is not meant to imply that there must be two separate pieces of flooring.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

What is claimed is:

1. A composition for joining a textile to a textile, a textile to a resilient floor covering, or a resilient floor covering to a resilient floor covering comprising:
from 10 weight percent (wt. %) to 60 wt. % of a polyvinyl butyral resin; and
from 40 wt. % to 90 wt. % of an organic solvent,
wherein the composition has a viscosity from 100 to 100,000 centipoise (cP).

2. The composition of claim 1, wherein the polyvinyl butyral resin has an average molecular weight of from 10,000 g/mol to 250,000 g/mol.

3. The composition of claim 1, wherein the polyvinyl butyral resin has a degree of acetalization of from 0 mol % to 20 mol %.

4. The composition of claim 1, wherein the polyvinyl butyral resin has an average polyvinyl hydroxyl content of from 10 wt. % to 30 wt. %.

5. The composition of claim 1, wherein the polyvinyl butyral resin is a virgin resin, recycled post-consumer resin, a recycled post-industrial resin, or combinations thereof.

6. The composition as in claim 1, wherein the organic solvent is at least one selected from the group consisting of an alcohol, an ether, an ester, a ketone, a hydrocarbon, terpineol, butyl carbitol, acetic acid, dimethyl sulfoxide, and combinations thereof.

7. The composition as in claim 6, wherein the alcohol is at least one selected from methanol, ethanol, propanol, isopropanol, butanol, isobutanol, diacetone alcohol, benzyl alcohol, and combinations thereof.

8. The composition as in claim 6, wherein the ether is at least one selected from dioxane, tetrahydrofuran, a glycol ether, and combinations thereof.

9. The composition of claim 8, wherein the glycol ether is at least one selected from 1-methoxy propanol-2, butyl glycol, 3-methyoxy-butanol-1, ethylene glycol monomethyl ether, ethylene glycol monoethyl ether, ethylene glycol monobutyl ether, dipropylene glycol n-butyl ether, and combinations thereof.

10. The composition of claim 6, wherein the ester is at least one selected from methoxy propyl acetate, methyl acetate, ethyl acetate, butyl acetate, acetic acid-3-methoxy-n-butylester, glycolic acid-n-butylester, dibasic esters, ethyl lactate, and combinations thereof.

11. The composition of claim 6, wherein the ketone is at least one selected from acetone, methylethylketone, methylisobutylketone, cyclohexanone, and combinations thereof.

12. The composition of claim 6, wherein the hydrocarbon is at least one selected from an aliphatic hydrocarbon, toluene, xylene, and combinations thereof.

13. The composition of claim 1, wherein the organic solvent is selected from the group consisting of alcohol, methyl acetate, acetone, and combinations thereof.

14. The composition of claim 1, further comprising 0 wt. % to 2 wt. % water.

15. The composition of claim 1, further comprising 0 wt. % to 25 wt. % of one or more plasticizers, one or more pigments, one or more antioxidants, or combinations thereof.

16. A composition for joining a textile to a textile, a textile to a resilient floor covering, or a resilient floor covering to a resilient floor covering comprising:
from 10 wt. % to 60 wt. % of a polyvinyl butyral resin;
from 40 wt. % to 90 wt. % of an organic solvent;
from 0 wt. % to 2 wt. % water;
from 0 wt. % to 25 wt. % plasticizers;
from 0 wt. % to 1 wt. % pigments;
from 0 wt. % to 1 wt. % antioxidants; and
from 0 wt. % to 1 wt. % additives or impurities retained in recycled content.

17. A composition for joining a textile to a textile, a textile to a resilient floor covering, or a resilient floor covering to a resilient floor covering comprising:
from 15 wt. % to 40 wt. % of a polyvinyl butyral resin; and
from 60 wt. % to 85 wt. % of an organic solvent,
wherein:
the polyvinyl butyral resin has an average molecular weight of from 33,000 g/mol to 55,000 g/mol;
the polyvinyl butyral resin has a degree of acetalization from 0.7 mol. % to 3 mol. %;
the polyvinyl butyral resin has a polyvinyl hydroxyl content from 12 wt. % to 21 wt. %;
the organic solvent comprises alcohol, methyl acetate, acetone, or all; and
the composition has a viscosity of from 1,000 to 3,000 centipoise.

18. A method of joining a first textile segment and a second textile segment, the method comprising:
applying the composition of claim 1 to a first edge of the first textile segment, or a second edge of the second textile segment, or both; and
contacting the first edge and the second edge.

19. A method of joining a textile segment and a resilient floor covering segment, the method comprising:
applying the composition of claim 1 to an edge of the textile segment, or an edge of the resilient floor covering segment, or both; and
contacting the edge of the textile segment and the edge of the resilient floor covering segment.

20. A method of joining a first resilient floor covering segment and a second resilient floor covering segment, the method comprising:
applying the composition of claim 1 to an edge of the first resilient floor covering segment, or an edge of the second resilient floor covering segment, or both; and
contacting the edge of the first resilient floor covering segment and the edge of the second resilient floor covering segment.

21. A method of joining a first resilient floor covering segment and a second resilient floor covering segment, the method comprising:
applying the composition of claim 1 to a side of the first resilient floor covering segment, or a side of the second resilient floor covering segment, or both; and
contacting the side of the first resilient floor covering segment and the side of the second resilient floor covering segment.

22. A material comprising:
the composition according to claim 1;
a first segment comprising a textile or a resilient floor covering; and
a second segment comprising a textile or a resilient floor covering,
wherein the composition is between the first segment and the second segment, and the composition durably joins the first segment and the second segment together.
